(19) United States
(12) Patent Application Publication
(10) Pub. No.: US 2005/0188795 A1
(43) Pub. Date: Sep. 1, 2005

(54) Spider

(75) Inventor: Lydia Katrena Woltz, East Point, GA (US)

Correspondence Address: LYDIA KATRENA WOLTZ, 2368 CONNALLY DRIVE, EAST POINT, GA, 30344, US

(73) Assignee: Lydia Katrena Woltz, East Point, GA (US)

(21) Appl. No.: 10/708,392

(22) Filed: Feb. 27, 2004

(51) Int. Cl. B25B 13/00

(52) U.S. Cl. 81/57.36

(57) ABSTRACT

What's new to my device, is that current standard drum keys tighten one lug/screw of a drum at one time; my device is a key tightens all of those keys simultaneously.

### BACKGROUND OF INVENTION

I thought of my design around 1989/1990 when I was playing drums in the marching band of Morris Brown College. I've haven't done much about it due to confusion about what I should do. I met with the Invention Submission Corporation in Atlanta, Ga. in 1999 and I talked to a couple of lawyers listed on the uspto.gov web site; afterwards I realized that the prices and type of services they provided (especially the prices of those services) were not really for the common person like myself; it was more for big companies. I would like to also humbly note that I am not a professional artist, grant writer, or an engineer and the descriptions and drawings within my application are in my own language. I named my device Spider, because it resembles a spider (or an octopus); I liked the name spider better. I will refer to parts of my device as “legs” because they resemble the legs of a spider.

### SUMMARY OF INVENTION

My design is a percussion/drum-key (my invention from here on referred to as “device”) that can simultaneously tighten all the lug nuts¹ on a drum at one time by turning one MAJOR-KEY which controls several smaller Minor-keys. The Minor-keys each work individually independent of the MAJOR-KEY. The MAJOR-KEY, when in a locked vs. unlocked position, always turn all the minor keys simultaneously in the same direction it itself is turning). The device should be able to operate while the “legs” of the device are at ANY length, position, height, or angle and that it should also be fully operational even if “leg” lengths are not the same.

¹ Lug Nuts are used to secure a drum head (the part of the drum that is beat upon) to the actual drum.

### BRIEF DESCRIPTION OF DRAWINGS

“The patent or application file contains at least one drawing executed in color. Copies of this patent or patent application publication with color drawing(s) will be provided by the Office upon request and payment of the necessary fee.”

I'd like to submit that I am not a professional artist and that ALL of my drawings are to show the functionality of my design.

FIG. 1—FIG. 1 was drawn to try to give the overall view of the design and to give an idea of what my design should look like without any descriptions to obstruct its view. FIG. 1B is a picture of a standard drum key, for convenience.

FIG. 2—FIG. 2 is FIG. 1 with brief descriptions to explain its operation.

FIG. 3—FIG. 3 is the side-view of one of the “spider legs”; its “legs” (in ANY position, length, height, or angle) should be fully operational even if the “leg” lengths are not the same. It will show: a) that the length of each leg should be adjustable, but adjustable with some tension (like the slide of a trombone) and b) the minor-key.

FIG. 4—FIG. 4 was drawn to show what the design would look like at different packing/storage stages (i.e., what it looks like when you're finished using it and getting ready to “put it up”).

FIG. 5—FIG. 5 is the master-key with a brief description of its function.

### DETAILED DESCRIPTION

My design is a percussion/“drum-key” that can simultaneously tighten all the lug nuts on a drum at one time by turning one MAJOR-KEY. At the “foot” or “head” of each “spider leg” is a minor-key. The device will allow the user to either tighten all the lugs on a drum, simultaneously by turning the MAJOR-KEY, or individually by turning each minor-key. The top of the MASTER-KEY should have the major turning handle and two toggle switches. Toggle switch 1—Controls clockwise or counterclockwise direction. Toggle switch 2—Locks or Unlocks MASTER-KEY. MASTER-KEY: When Locked, Controls all Minor-keys; when turned all minor-keys turn accordingly. When Unlocked, Minor-keys work independently of MASTER-KEY & other Minor-keys. Minor-keys: Are dependent on MASTER-KEY when MASTER-KEY is locked. When MASTER-KEY is Unlocked, Minor-keys work independently of MASTER-KEY & other Minor-keys. Drums are usually adjusted extremely tight!

The bottom of each minor key would be made to fit over the lugs of a drum lug (made to fit those lugs as an ordinary drum key fits the lugs on an average drum).

The device will work in both clockwise or counterclockwise directions and should be expandable from a diameter ranging between 10 inches and 36 inches for the average sized device or 36 inches to 74 inches for a large sized device.

Note: Tension strength within the device will have to be able to take an extreme amount of ‘pull’. It would basically be made to work like a multi-legged ratchet wrench. It should be light-weight and most importantly very durable.

### BRIEF SUMMARY OF THE SEVERAL VIEWS OF THE DRAWINGS

“The patent or application file contains at least one drawing executed in color. Copies of this patent or patent application publication with color drawing(s) will be provided by the Office upon request and payment of the necessary fee.”

I'd like to submit that I am not a professional artist and that ALL of my drawings are to show the functionality of my design.

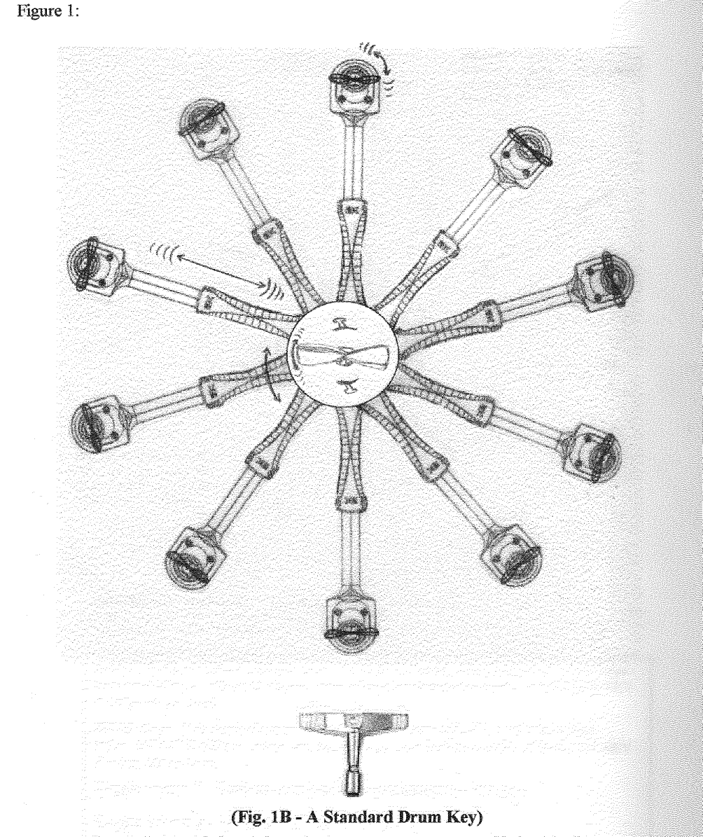

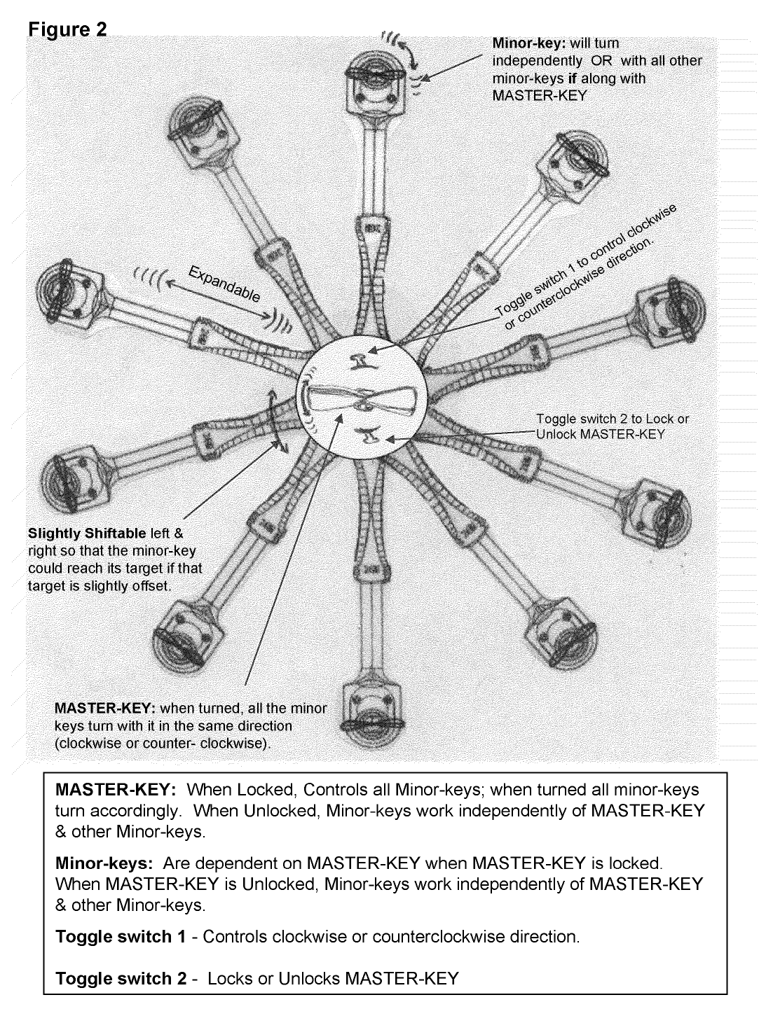

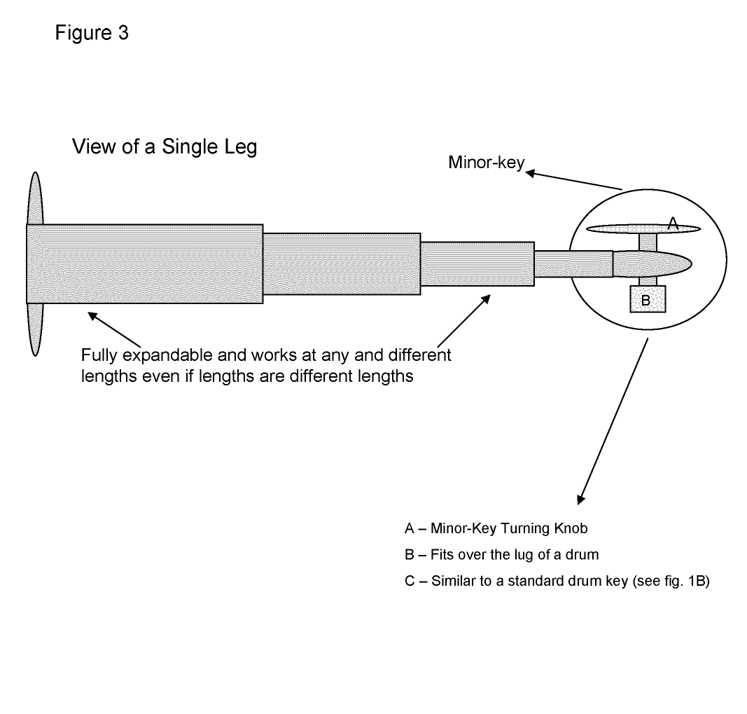

FIG. 1—FIG. 1 was drawn to try to give the overall view of the design and to give an idea of what my design should look like without any descriptions to obstruct its view. FIG. 1B is a picture of a standard drum key, for convenience.

FIG. 2
A—Minor-key: will turn independently OR with all other minor-keys if along with MASTER-KEY. Minor-keys are dependent on MASTER-KEY when MASTER-KEY is locked. When MASTER-KEY is Unlocked, Minor-keys work independently of MASTER-KEY & other Minor-keys.
B—Toggle switch 1 to control clockwise or counterclockwise direction.
C—Toggle switch 2 to Lock or Unlock MASTER-KEY
D—MASTER-KEY: when turned, all the minor keys turn with it in the same direction (clockwise or counter-clockwise). When Locked, Controls all Minor-keys; when turned all minor-keys turn accordingly. When Unlocked, Minor-keys work independently of MASTER-KEY & other Minor-keys.
E—Slightly Shiftable left & right so that the minor-key could reach its target if that target is slightly offset.

FIG. 3—FIG. 3 is the side-view of one of the “spider legs”; its “legs” (in ANY position, length, height, or angle) should be fully operational even if the “leg” lengths are not the same. It will show:
a) that the length of each leg should be adjustable, but adjustable with some tension (like the slide of a trombone) and b) the minor-key.
C—The (encircled) is the “Minor-key”—It fits over the lug of a drum & is similar to a standard drum key (see FIG. 1B).
D—Fully expandable and works at any and different lengths even if lengths are different lengths.

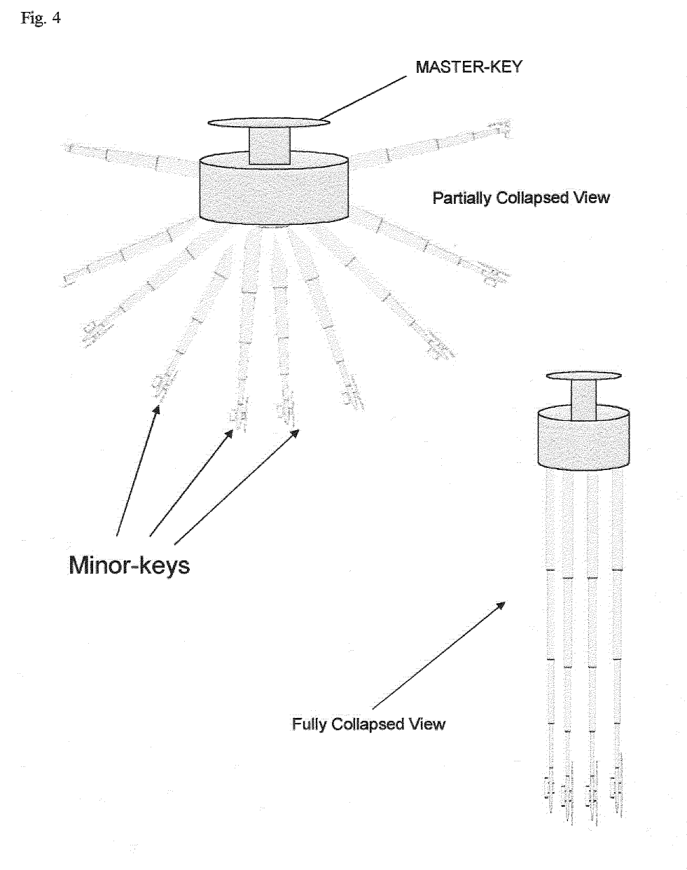

FIG. 4—FIG. 4 was drawn to show what the design would look like at different packing/storage stages (i.e., what it looks like when your finished using it and getting ready to “put it up”).

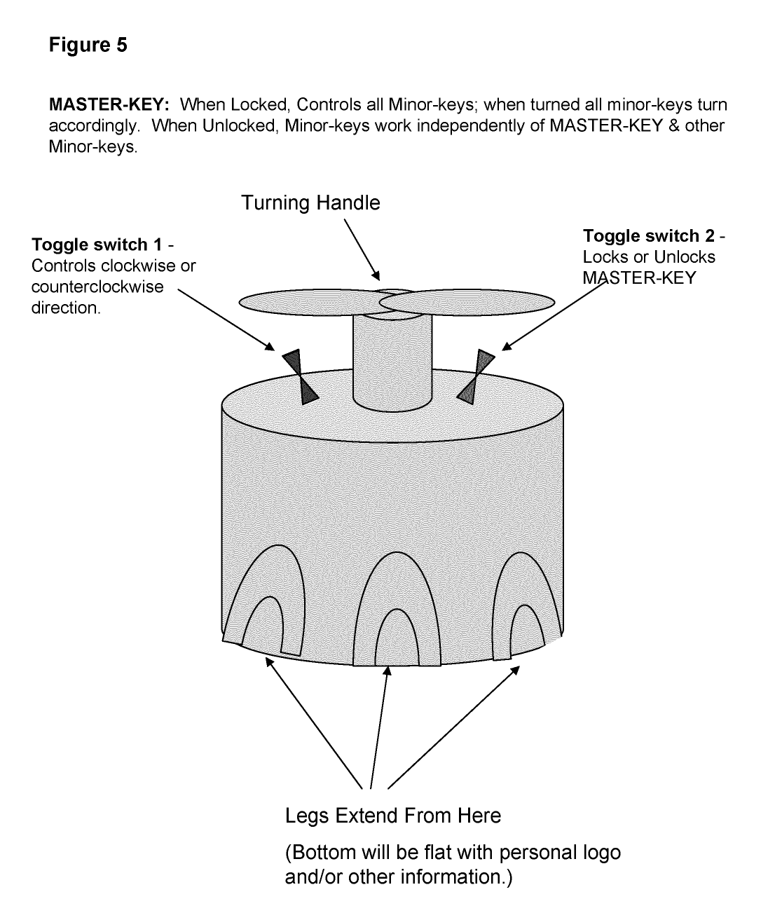

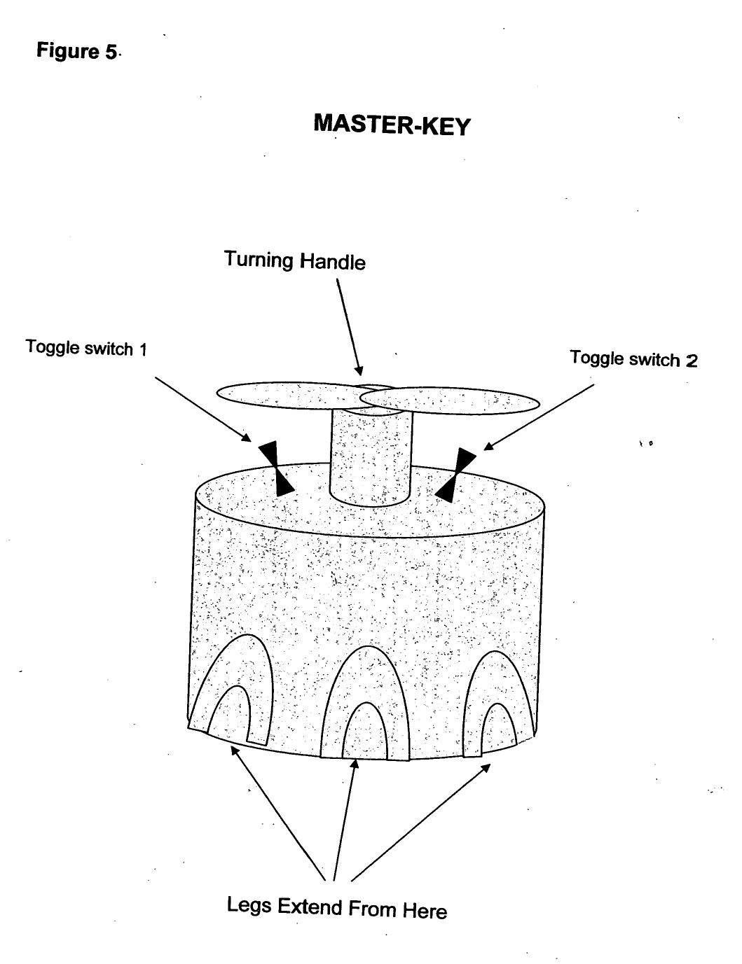

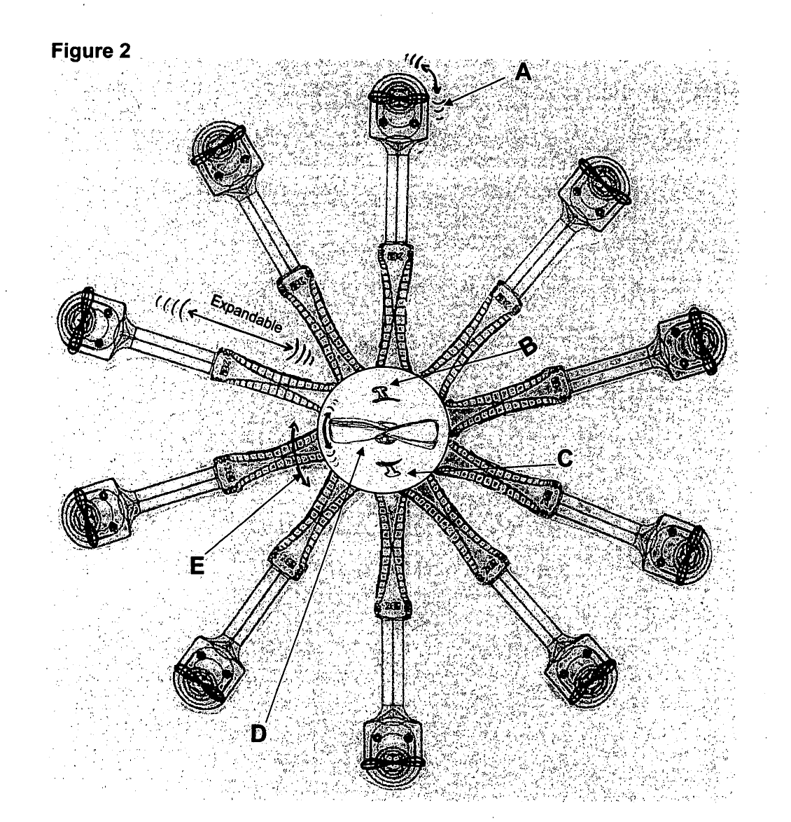

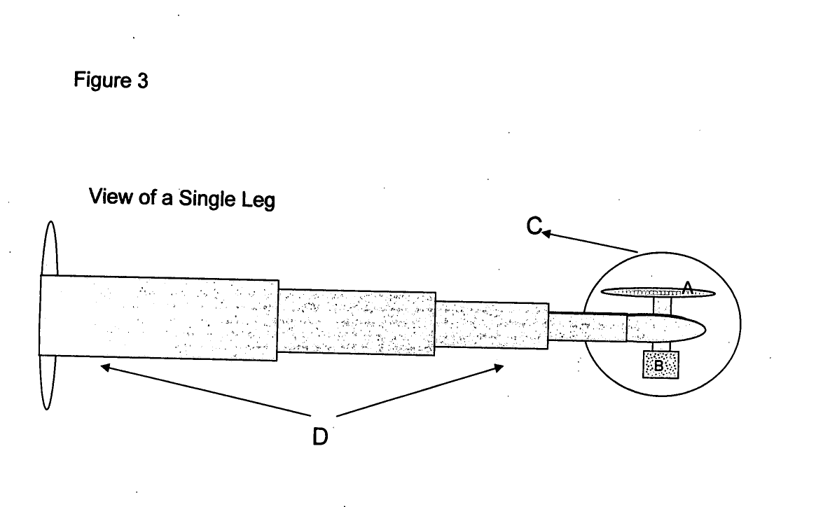

FIG. 5—MASTER-KEY: When Locked, Controls all Minor-keys; when turned all minor-keys turn accordingly. When Unlocked, Minor-keys work independently of MASTER-KEY & other Minor-keys.
Toggle Switch 1—Controls clockwise or counterclockwise direction.
Toggle Switch 2—Locks or Unlocks MASTER-KEY.
Legs Extend From Here—(Bottom of MASTER-KEY will be flat with personal logo and/or other information).

1. I Lydia Katrena Woltz claim that I am the sole inventor of the idea and design of a drum key that simultaneous tightens more than one lug of a drum at a time that I have titled “The Spider—by Lydia Woltz”
